(19) United States
(12) Patent Application Publication
(10) Pub. No.: US 2007/0047220 A1
(43) Pub. Date: Mar. 1, 2007

(54) Backlight unit, display device having the same and driving method of the same

(76) Inventors: Seock-hwan Kang, Suwon-si (KR); Gi-cherl Kim, Yongin-si (KR); Sang-yu Lee, Yongin-si (KR); Joo-woan Cho, Seoul (KR)

Correspondence Address: CANTOR COLBURN, LLP, 55 GRIFFIN ROAD SOUTH, BLOOMFIELD, CT, 06002, US

(21) Appl. No.: 11/473,719

(22) Filed: Jun. 23, 2006

(30) Foreign Application Priority Data
Aug. 26, 2005 (KR) 2005-0078960

(51) Int. Cl. G09F 13/04

(52) U.S. Cl. 362/97

(57) ABSTRACT

An LCD including a backlight unit including a light source unit, an optical fiber transmitting light from the light source unit, an optical sensor receiving the light from the optical fiber and sensing a color of light, a light source driving part providing power to the light source unit and a light source controller controlling the light source driving part so that the light source unit provides a desired color of light based on the color sensed by the optical sensor.

This application claims priority to Korean Patent Application No. 2005-0078960, filed on Aug. 26, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a backlight unit, a display device having the same and a driving method of the same, and more particularly to a backlight unit, a display device having the same and a driving method of the same which senses a color of light provided with a light source unit including a point light source, using an optical fiber.

2. Description of the Related Art

A flat display device, such as a liquid crystal display (LCD), a plasma display panel (PDP) and an organic light emitting diode (OLED), has been developed in place of a CRT.

The LCD includes an LCD panel which includes a thin film transistor (TFT) substrate, a color filter substrate and liquid crystals interposed between both substrates. The LCD panel does not emit light by itself, thus there is disposed a backlight unit in the rear of the TFT substrate to provide light. Transmittance of the light irradiated from the backlight unit is adjusted according to the alignment of the liquid crystals. The LCD panel and the backlight unit are accommodated in a chassis.

The backlight unit is either an edge type backlight unit or a direct type backlight unit according to a position of a light source.

In the edge type backlight unit, a light source is installed on a side of a light guiding plate. The edge type backlight unit is typically used with a small LCD device such as a monitor for a laptop computer and a monitor for a desktop computer. The edge type backlight unit has various advantages such as high uniformity of light, a long life and so on. Furthermore, the LCD may become thinner using the edge type backlight unit.

The direct type backlight unit has been developed by the evolution of a large-screen LCD. In the direct type backlight unit, a plurality of light sources are disposed under the LCD panel and directly emit light to the surface of the LCD panel. The direct type backlight unit uses the available light sources more than the edge type backlight unit. Therefore, the direct type backlight unit obtains higher brightness, but the brightness is not uniform.

A point light source, such as light emitting diode (LED), has been notable as a direct type backlight unit. The point light source provides white color light by mixing light from point light sources emitting different colors.

However, the point light sources of each color are driven separately, and thus it is hard to control color balance. Also, wavelength of light emitted from each point light source is changed due to temperature rise when the point light sources are driven. Accordingly, it is difficult for the point light source to provide uniform colors of light.

### BRIEF-SUMMARY OF THE INVENTION

One exemplary embodiment provides a backlight unit which is capable of adjusting a color of light provided from a light source unit.

Another exemplary embodiment provides a display device including a backlight unit which is capable of adjusting a color of light provided from a light source unit.

Another exemplary embodiment provides a driving method of a backlight unit which is capable of adjusting a color of light provided from a light source unit.

In another exemplary embodiment, an LCD includes a backlight unit including a light source unit, an optical fiber transmitting light from the light source unit, an optical sensor receiving the light from the optical fiber and sensing a color of light, a light source driving part providing power to the light source unit and a light source controller controlling the light source driving part so that the light source unit provides a desired color of light based on the color sensed by the optical sensor.

In another exemplary embodiment, the backlight unit further includes a cover accommodating the light source unit, wherein the optical sensor is disposed in the rear of the cover.

In another exemplary embodiment, the optical sensor and the light source controller are mounted on a same substrate.

In another exemplary embodiment, the optical fiber is provided in plural.

In another exemplary embodiment, the optical sensor is connected to at least two optical fibers

In another exemplary embodiment, the backlight unit further includes an optical member disposed between the optical fibers and the optical sensor and filtering/leveling light from the optical fibers.

In another exemplary embodiment, one end portion of at least one of the optical fibers is disposed substantially in the center of the light source unit.

In another exemplary embodiment, one end portion of a plurality of the optical fibers is disposed at lateral sides of the light source unit.

In another exemplary embodiment, the light source unit includes a green LED, a red LED and a blue LED.

In another exemplary embodiment, the backlight unit further includes a lens disposed at one end portion of the optical fibers.

In another exemplary embodiment, the light source unit includes a point light source and one end portion of the optical fibers is adjacently disposed to the point light source.

In another exemplary embodiment, the light source unit includes a plurality of point light sources and the light source controller controls the light source driving part according to colors of the point light sources.

In another exemplary embodiment, the optical fibers receive light at plural points corresponding to a plurality of areas of the light source unit and the light source controller controls the light source driving part according to the areas.

In another exemplary embodiment, a display device includes a display panel, a light source unit disposed in the rear of the display panel, an optical fiber transmitting light from the light source unit, an optical sensor receiving the light from the optical fiber and sensing a color of light, a light source driving part providing electric power to the light source unit and a light source controller controlling the light source driving part so that the light source unit provides a desired color of light based on the color sensed by the optical sensor.

In another exemplary embodiment, the display panel is an LCD panel.

In another exemplary embodiment, a driving method of a backlight unit includes receiving light from a light source unit through an optical fiber, the light source unit including a plurality of point light sources emitting two or more different colors, respectively, sensing a color of the received light and controlling electric power provided to the light source unit so that the light source unit provides a desired color of light based on the sensed color.

In another exemplary embodiment, the electric power is controlled by emitting colors of the plurality of point light sources.

In another exemplary embodiment, the optical fiber senses light at plural points in a plurality of different areas of the light source unit and the electric power is controlled according to the areas of the light source unit which is divide into plural areas.

In another exemplary embodiment, a method of forming a backlight unit includes forming a light source unit, disposing a first end of an optical fiber proximate to the light source unit, the optical fiber transmitting light from the light source unit, connecting a second end of the optical fiber to an optical sensor receiving light from the optical fiber and sensing a color of the received light, disposing a light source driving part between the optical sensor and the light source unit and powering the light source unit and connecting a light source controller between the light source unit and the optical sensor, the light source controller controlling the light source driving part such that the light source unit provides a desired color of light based on the sensed color of light.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is an exploded perspective view of an exemplary embodiment of an LCD according to the present invention;

FIG. 2 is a rear view of the exemplary embodiment of the LCD in FIG. 1 according to the present invention;

FIG. 3 is a control block diagram of the an exemplary embodiment of a backlight unit according to the present invention; and

FIGS. 4 through 7 are drawings of other exemplary embodiments of an LCD according to the present invention.

### DETAILED DESCRIPTION OF THE INVENTION

Reference will now be made in detail to exemplary embodiments of the present invention, examples of which are illustrated in the accompanying drawings, wherein like reference numerals refer to like elements throughout. The embodiments are described below in order to explain the present invention by referring to the figures. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower”, “under,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” other elements or features would then be oriented “upper” or “above” the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

In the following exemplary embodiments, a point light source will be described with an LED as an example, but it is not limited to an LED. Other point light sources incorporated into the LCDs of the exemplary embodiments described herein would also be within the scope of these embodiments. Also, a display device will be described with an LCD as an example, but it is not limited thereto. Other display devices including a backlight unit would also be within the scope of these embodiments.

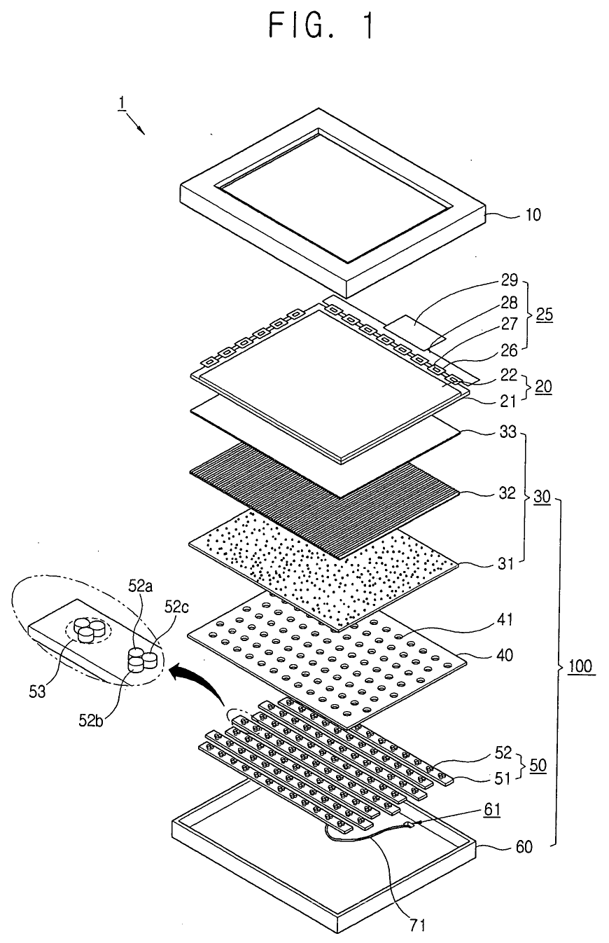

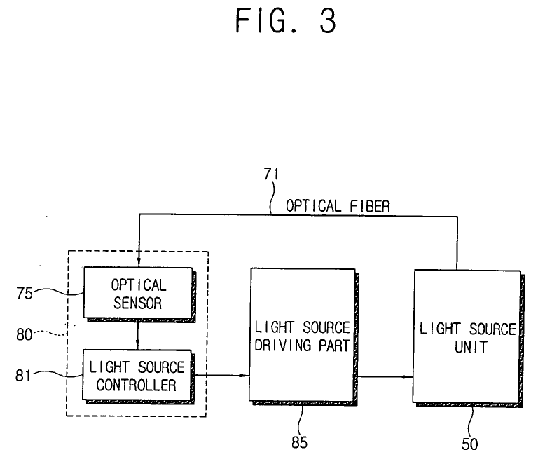

Referring to FIGS. 1 through 3, an exemplary embodiment of the present invention will be described as follows.

In the following exemplary embodiment, a direct type backlight unit will be described as a backlight unit, but an edge type backlight unit may be employed as well. Also, white color light will be described as light provided to an LCD panel, but it is not limited thereto.

An LCD 1 includes an LCD panel 20 and a backlight unit 100 providing light to the LCD panel 20. The LCD panel 20 is accommodated in an upper cover 10 and a lower cover 60. The backlight unit 100 includes a light control member 30, a reflecting plate 40, a light source unit 50, the lower cover 60, an optical fiber 71, an optical sensor 75, a light source controller 81 and a light source driving part 85.

The LCD panel 20 includes a TFT substrate 21 where TFTs are formed, a color filter substrate 22 which faces the TFT substrate 21 and a liquid crystal layer (not shown) interposed between both substrates 21, 22. The LCD panel 20 adjusts an alignment of the liquid crystal layer to thereby display images.

However, the LCD panel 20 does not emit light by itself, thus there is provided the light source unit 50 in the rear of the LCD panel 20 to provide light to the LCD panel 20. A driving part 25 is provided on one side of the TFT substrate 21 to provide driving signals. The driving part 25 includes a flexible printed circuit (FPC) 26 of which one side is connected to the TFT substrate 21, a driving chip 27 mounted on the FPC 26, a connective circuit board 28 connected to another side of the FPC 26 and encompassing a lateral side of the backlight unit 100 and a driving circuit board 29 connected to the connective circuit board 28 and disposed in the rear of the lower cover 60.

The driving part 25 shown in FIG. 1 may be formed as a chip on film (COF) type. However, any other type suitable for the purpose described herein, such as tape carrier package (TCP), chip on glass (COG) or the like, is available as the driving part 25. Alternative embodiment include configurations where the driving part 25 may be formed on the TFT substrate 21 while lines are assembled.

The light control member 30 disposed in the rear of the LCD panel 20 includes a diffusion plate 31, a prism film 32 and a protection film 33.

The diffusion plate 31 may include a base plate and a coating layer, such as beads, formed on the base plate. The diffusion plate 31 diffuses light from the light source unit 50, thereby improving brightness uniformity.

The prism film 32 includes prisms, such as triangular prisms, formed in a predetermined alignment thereon. The prism film 32 concentrates the light diffused from the diffusion plate 31 substantially perpendicularly to a surface of the LCD panel 20. In exemplary embodiments, two prism films 32 may be used and/or micro prisms formed on each of the prism films 32 make a predetermined angle with each other. The light passing through the prism film 32 mostly continues vertically, thereby forming a uniform brightness distribution. In alternative exemplary embodiments, a reflective polarizing film may be used along with the prism film 32 or only the reflective polarizing film may be used without the prism film 32. The protection film 33 disposed at the top of the light control member 30 protects the prism film 32, which is vulnerable to scratching.

A reflecting plate 40 is disposed on a portion of a light member 51, such as an LED circuit board where light sources 52, such as LEDs, are not mounted. Light source (LED) through holes 41 are disposed in the reflecting plate 40 substantially corresponding to an arrangement of the light sources 52, or LEDs 52. Individual light sources 52 may be collected into a light source group 53. In one exemplary embodiment, an LED group 53 including three LEDs 52 is disposed in the LED through hole 41. In exemplary embodiments, a size (dimensions) of the LED through hole 41 may be formed larger than the LED group 53 to accommodate the LED group 53.

The reflecting plate 40 reflects light which is incident downward and provides it to the diffusion plate 31. The reflecting plate 40 may include, but is not limited to polyethylene terephthalate (PET) or polycarbonate (PC), or the reflecting plate 40 may be coated with a reflective material such as silver or aluminum. The reflecting plate 40 may also is be formed thick enough not to shrink due to heat generated from the LED 52.

Referring to FIG. 1, the LED circuit board 51 has a substantially bar shape. In exemplary embodiments, multiple LED circuit boards 51 may be arranged in the LCD 1. In one exemplary embodiment, eight LED circuit boards 51 are disposed by equal spaces substantially parallel with each other. In another exemplary embodiment, the LED circuit board 51 may include aluminum having an excellent thermal conductivity, since the LED 52 generates heat. Alternative configurations of the backlight unit 100 may further include a heat pipe, a radiating fin, a cooling fan, etc. to easily release the heat from the LED 52.

The LEDs 52 are mounted on the LED circuit board 51 and disposed to extend in substantially the entire rear of the LCD panel 20. The LED group 53 may include colored light sources 52. In one exemplary embodiment, the LED group 53 includes three LEDs 52, such as one red LED 52a, one green LED 52b and one blue LED 52c which are arranged in a regular triangle.

The LED group 53 is disposed at regular intervals on the LED circuit board 51. In exemplary embodiments, the LED groups 53 on adjacent LED circuit boards 51 may be alternately disposed.

The LED group 53 may include three different colors of LEDs 52 to thereby provide white color light. The LED 52 is spaced from the reflecting plate 40 at a predetermined interval, thereby mixing light from each of the LEDs 52 therebetween, whereby the backlight unit 100 may provide the white color light to the LCD panel 20.

However, the backlight unit 100 may not provide the white color light, since a light emitting characteristic of the LED 52 due to temperature rise of the backlight unit 100 is changed when the LCD 1 is driven. In one exemplary embodiment the optical fiber 71 and the optical sensor 75 are used to measure a color characteristic of light provided from the light source unit 50.

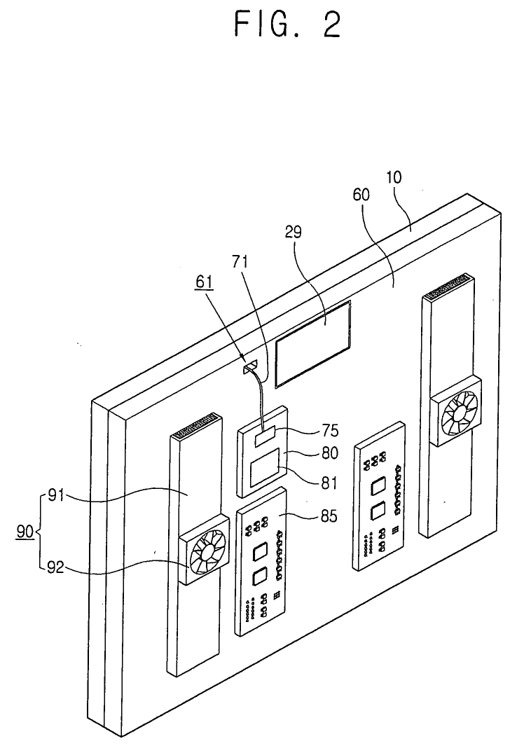

Referring to FIGS. 1 and 2, one end of the optical fiber 71 is adjacent to the light source unit 50 to receive light from the light source unit 50 and the other end thereof is connected to the optical sensor 75 to transmit light from the light source unit 50. In one exemplary embodiment, the one end of the optical fiber 71 is disposed nearly in the center of the light source unit 50 and extended to the rear of the lower cover 60 through a passing hole 61 formed in the lower cover 60. The optical fiber 71 occupies minimal space and does not unduly influence light characteristic of the light source unit 50. Further, the optical fiber 71 is pliable so as to allow disposition in any of a variety of positions.

The optical sensor 75 senses the color characteristic of light transmitted from the light source unit 50 through the optical fiber 71, then transmits the color characteristic to the light source controller 81. In one exemplary embodiment, the optical sensor 75, along with the light source controller 81, is mounted in a substrate 80 disposed in the rear of the lower cover 60. Advantageously, a manufacturing process may be simplified and a manufacturing cost decreases. Also, the optical sensor 75 and the light source controller 81 do not need to be connected by a cable, thereby reducing inflow of noise.

In alternative exemplary embodiments, the optical sensor 75 and the light source controller 81 may be mounted in the driving circuit board 29 or in the light source driving part 85. The optical sensor 75 may be disposed in the light source controller 81. The optical fiber 71 may be a detachable-connector type, such that it is easily assembled and disassembled.

The light source driving part 85 provides electric power to the LED 52 through the LED circuit board 51. In exemplary embodiments, the light source driving part 85 may adjust the electric power supply by colors and/or positions of the LED 52. The light source controller 81 controls the light source driving part 85 based on the color characteristic sensed by the optical sensor 75 so as to adjust the electric power which is supplied to the LED 52. In one exemplary embodiment, when the optical sensor 75 senses that red light is insufficient, more electric power is provided to the red LED 52a and/or less electric power is provided to the green LED 52b and the blue LED 52c.

Referring again to FIG. 2, a radiating part 90 may be formed in the rear of the lower cover 60 to radiate heat which is generated in the LED 52. The radiating part 90 includes a fin 91 which has a large area to contact with air and a cooling fan 92.

In the illustrated exemplary embodiments, light from the light source unit 50 can be controlled to have a desirable color. The position of the optical fiber 71 can be easily adjusted, thereby easily obtaining color information on a required part and not adding substantially cost. Further, the optical fiber 71 does not use an electric signal, thus noise is not generated when it transmits a signal at a relatively long distance.

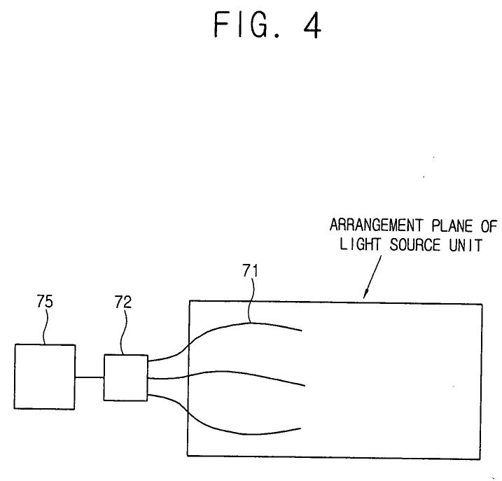

Hereinafter, other exemplary embodiments of an LCD according to the present invention will be described as referring to FIGS. 4 through 7.

Referring to FIG. 4, three optical fibers 71 are arranged relative to the light source unit 50. One of the optical fibers 71 is disposed substantially in the center of a plane where a light source unit 50 is disposed and the others of the optical fibers 71 are disposed in sides of the plane, on either side of the one optical fiber 71 in the center of the plane. The optical fiber 71 does not occupy much space and does not significantly influence light characteristic of the light source unit 50 even though multiple optical fibers 71 are employed.

An optical member 72 is disposed between the three optical fibers 71 and an optical sensor 75. The optical member 72 filters light transmitted from the three optical fibers 71. In exemplary embodiments, the optical member 72 may provide light transmitted from only one of the optical fibers 71 to the optical sensor 75 or may average the light from multiple optical fibers 71, such as from the three optical fibers 71, thereby providing the averaged light to the optical sensor 75.

With the multiple optical fibers 71 and the optical member 72, the optical sensor 75 senses light provided from the light source unit 50 at a plurality of points. Advantageously, a more exact color characteristic is able to be sensed. Also, since only one optical sensor 75 is used although a plurality of optical fibers 71 are used, a configuration of the LCD 1 is simplified and additional cost is slight.

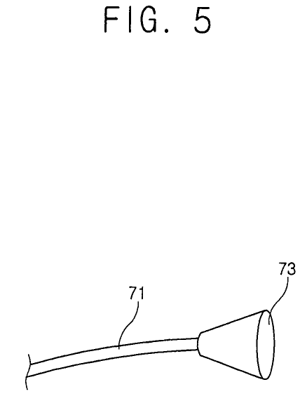

Referring to FIG. 5, an optical fiber 71 includes a lens 73 disposed at the end of thereof. The lens 73 adjusts angle and wavelength of light sensed by the optical fiber 71, so that the optical fiber 71 may selectively sense light. In one exemplary embodiment, if a lens 73 which widens the angle of light sensed by the optical fiber 71 is used, the color characteristic of most of or essentially the entire light source unit 50 may be sensed with a minimal number of optical fiber 71.

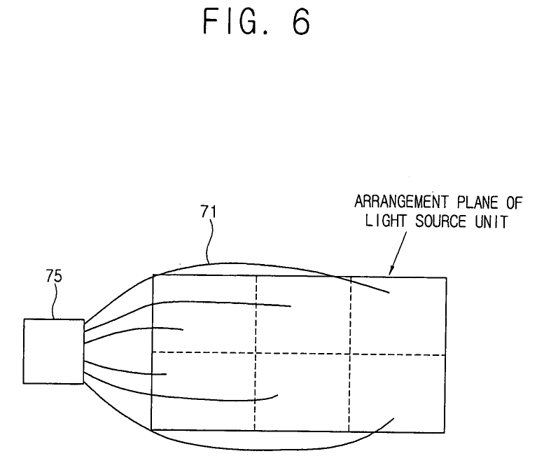

Referring to FIG. 6, a light source unit 50 is divided into plural areas and optical fibers 71 are disposed in each of the areas. In exemplary embodiments, an optical member 72 may be disposed between the optical fiber 71 and/or an optical sensor 75 so as to filter or level light.

In another exemplary embodiment, a light source driving part 85 may be employed to adjust electric power provided to an LED 52 in each or a plurality of the areas. Advantageously, it is possible to sense color and to adjust the electric power by each of the areas. Alternative embodiments include configurations where an LED circuit board 51 may be separately be disposed in each or multiple of the areas of the light source unit 50.

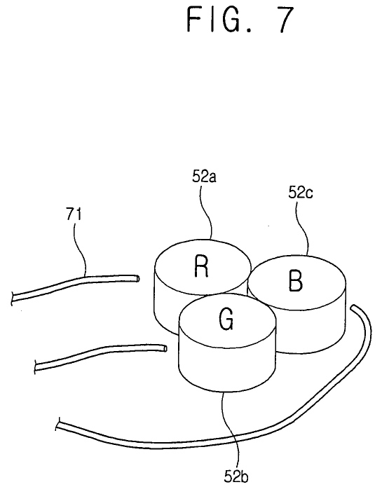

Referring to FIG. 7, optical fibers 71 are disposed adjacently to a red LED 52a, a green LED 52b and a blue LED 52c, respectively. The optical fibers 71 corresponding to the various LEDs 52 sense light from the adjacent color of the LEDs. In another exemplary embodiment, a lens 73 may be installed at the end of the optical fiber 71 to limit receiving angle of light.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A backlight unit comprising:
a light source unit;
an optical fiber transmitting light from the light source unit;
an optical sensor receiving the light from the optical fiber and sensing a color of light;
a light source driving part providing power to the light source unit; and
a light source controller controlling the light source driving part so that the light source unit provides a desired color of light based on the color sensed by the optical sensor.

2. The backlight unit according to claim 1, further comprising a cover accommodating the light source unit, wherein the optical sensor is disposed in the rear of the cover.

3. The backlight unit according to claim 2, wherein the optical sensor and the light source controller are mounted on a same substrate.

4. The backlight unit according to claim 2, wherein the optical fiber is provided in plural.

5. The backlight unit according to claim 4, wherein the optical sensor is connected to at least two of the optical fibers.

6. The backlight unit according to claim 5, further comprising an optical member disposed between the optical fibers and the optical sensor and filtering/leveling light from the optical fibers.

7. The backlight unit according to claim 4, wherein one end portion of at least one of the optical fibers is disposed substantially in a center of the light source unit.

8. The backlight unit according to claim 4, wherein one end portion of a plurality of the optical fibers is disposed at lateral sides of the light source unit.

9. The backlight unit according to claim 4, wherein the light source unit comprises a green light emitting diode (LED), a red LED and a blue LED.

10. The backlight unit according to claim 4, further comprising a lens disposed at one end portion of each of the optical fibers.

11. The backlight unit according to claim 4, wherein the light source unit comprises a point light source and one end portion of the optical fibers is adjacently disposed to the point light source.

12. The backlight unit according to claim 4, wherein the light source unit comprises a plurality of point light sources and the light source controller controls the light source driving part according to colors of the point light sources.

13. The backlight unit according to claim 4, wherein the optical fibers receive light at plural points corresponding to a plurality of areas of the light source unit and the light source controller controls the light source driving part according to the areas.

14. A display device comprising:
a display panel;
a light source unit disposed in the rear of the display panel;
an optical fiber transmitting light from the light source unit;
an optical sensor receiving the light from the optical fiber and sensing a color of the light;
a light source driving part providing electric power to the light source unit; and
a light source controller controlling the light source driving part so that the light source unit provides a desired color of light based on the color sensed by the optical sensor.

15. The display device according to claim 14, further comprising a cover accommodating the light source unit, wherein the optical sensor is disposed in the rear of the cover.

16. The display device according to claim 15, wherein the optical sensor and the light source controller are mounted in the same substrate.

17. The display device according to claim 16, wherein the optical sensor is connected to at least two of the optical fiber.

18. The display device according to claim 14, wherein the display panel is an LCD panel.

19. The display device according to claim 14, wherein the light source unit comprises a green LED, a red LED and a blue LED.

20. A driving method of a backlight unit, the method comprising:
receiving light from a light source unit through an optical fiber, the light source unit comprising a plurality of point light sources emitting two or more different colors;
sensing a color of the received light; and
controlling electric power provided to the light source unit so that the light source unit provides a desired color of light based on the sensed color.

21. The driving method according to claim 20, wherein the electric power is controlled by emitting colors of the plurality of point light sources.

22. The driving method according to claim 21, wherein the optical fiber senses light at plural points in a plurality of different areas of the light source unit and the electric power is controlled according to the areas of the light source unit.

23. A method of forming a backlight unit, the method comprising:
forming a light source unit;
disposing a first end of an optical fiber proximate to the light source unit, the optical fiber transmitting light from the light source unit;
connecting a second end of the optical fiber to an optical sensor receiving light from the optical fiber and sensing a color of the received light;
disposing a light source driving part between the optical sensor and the light source unit and powering the light source unit; and
connecting a light source controller between the light source unit and the optical sensor, the light source controller controlling the light source driving part such that the light source unit provides a desired color of light based on the sensed color of light.

24. The method according to claim 23, wherein the forming a light source comprises:
disposing a plurality of point light sources on a circuit board, a quantity of point light sources forming a light source group; and
arranging a plurality of circuit boards substantially parallel to each other;
wherein light source groups on adjacent circuit boards are arranged alternately to each other.

25. The method according to claim 24, wherein the quantity of point light sources is three and each light source group comprises a green, a red and a blue point light source.
